(19) United States
(12) Patent Application Publication
(10) Pub. No.: US 2008/0181150 A1
(43) Pub. Date: Jul. 31, 2008

(54) Scheduling apparatus and method in broadband wireless access system

(75) Inventors: Jeong-Jae Won, Hwaseong-si (KR); Se-Jin Kim, Jeongeup-si (KR); Choong-Ho Cho, Cheonan-si (KR); Hyong-Woo Lee, Yuseong-gu (KR)

Correspondence Address: DOCKET CLERK, P.O. DRAWER 800889, DALLAS, TX, 75380, US

(73) Assignee: SAMSUNG ELECTRONICS Co., LTD., Suwon-si (KR)

(21) Appl. No.: 12/011,326

(22) Filed: Jan. 25, 2008

(30) Foreign Application Priority Data
Jan. 26, 2007 (KR) 2007-0008419

(51) Int. Cl. H04B 7/00

(52) U.S. Cl. 370/310

(57) ABSTRACT

A scheduling apparatus and method in a Broadband Wireless Access (BWA) system are provided. A transmitting apparatus includes a storage for buffering a predetermined number of pieces of past channel information with respect to all terminals; a predictor for predicting a future channel status for each terminal by using the predetermined number of pieces of past channel information; and a scheduler for scheduling by assigning a high priority to a terminal of which the future channel status has possibility of becoming worse, by using channel prediction values obtained from the predictor.

### CROSS-REFERENCE TO RELATED APPLICATION(S) AND CLAIM OF PRIORITY

This application claims priority under 35 U.S.C. §119(a) to a Korean patent application filed in the Korean Intellectual Property Office on Jan. 26, 2007 and assigned Serial No. 2007-8419, the entire disclosure of which is hereby incorporated by reference.

### TECHNICAL FIELD OF THE INVENTION

The present invention relates to a scheduling apparatus and method in a wireless communication system. More particularly, the present invention relates to a scheduling apparatus and method using channel prediction in a Broadband Wireless Access (BWA) system.

### BACKGROUND OF THE INVENTION

Recently, with the increasing interest on wireless multimedia contents and Internet services, there is a growing demand on data transmission techniques with a high capacity and a high speed. For example, research is being conducted for the effective use of limited wireless resources in various methods, such as, Code Division Multiple Access (CDMA), Orthogonal Frequency Division Multiplexing (OFDM), and Multiple Input Multiple Output (MIMO). In particular, the OFDM can transmit large volume data and video data (e.g., Moving Picture Experts Group (MPEG) 4) by using a broadband modulation/demodulation method, and is recently used in a Digital Video Technology (DVT) and an Institute of Electrical and Electronics Engineers (IEEE) 802.11g. Along with the MIMO, the OFDM has now been recognized a core technology of 4th Generation (4G).

Although the BWA system using the OFDM technique can transmit higher volume data in comparison with any other techniques used up to now, a Quality of Service (QoS) for various multimedia services cannot be ensured when the OFDM technique is used alone. That is, in a next generation mobile communication system, not only voice data but also QoS of traffic classes having different characteristics must be satisfied. Therefore, control (i.e., packet scheduling) needs to be performed in a Media Access Control (MAC) layer.

Conventionally, packet scheduling has been proposed by considering throughput, delay, and complexity. For fairness, various algorisms have been proposed, such as, a lead and lag model (i.e., leading, lagging, in sync) or a compensation model.

For example, a Proportional Fairness (PF) algorithm used in the CDMA2000 is designed to provide all terminals with fair services. However, the PF algorithm has a demerit in that throughput sharply decreases when the number of users exceeds a predetermined level. In a max Carrier to Interference (C/I) algorithm, a user having the best channel status has priority. Although the max C/I algorithm may show good performance in terms of throughput, disadvantageously, a wireless resource may be exclusively used by a user located near a Base Station (BS).

As such, algorithms proposed up to now are designed by considering one aspect (e.g., fairness), and thus it is difficult to apply these algorithms without alteration to the next generation system which concurrently provides services each having a different feature. A BS uses channel information fed back from a terminal. In this case, if the channel information does not indicate a channel used at a time when data is transmitted, a complex scheduling operation may result in an adverse effect. Therefore, in an environment where channel information used in scheduling does not indicate a channel used at a time when data is transmitted in practice, there is a need for a method of increasing reliability of channel information by considering mobility of a terminal.

Meanwhile, scheduling may be understood as an operation of selecting users to which a service is provided in a current frame. As mentioned above, a complex scheduling algorithm is useless in a situation where a channel cannot be correctly known at a time when data is transmitted in practice. Therefore, there is a need for a method of selecting users by using a much simpler algorithm.

### SUMMARY OF THE INVENTION

To address the above-discussed deficiencies of the prior art, it is a primary aspect of the present invention to address at least the above-mentioned problems and/or disadvantages and to provide at least the advantages described below. Accordingly, an aspect of the present invention is to provide an apparatus and method for predicting a future channel status and for scheduling by using the predicted channel status in a wireless communication system.

Another aspect of the present invention is to provide an apparatus and a method for predicting a future channel status for each user and for assigning a scheduling priority to each user according to the predicted channel status in a wireless communication system.

Another aspect of the present invention is to provide an apparatus and a method for scheduling by considering mobility of a user in a wireless communication system.

Another aspect of the present invention is to provide an apparatus and a method for scheduling by assigning a high priority to a terminal of which a channel level has a possibility of becoming worse in a wireless communication system.

Another aspect of the present invention is to provide an apparatus and a method for scheduling by assigning a low priority to a terminal of which a channel level has possibility of becoming better in a wireless communication system.

According to an aspect of the present invention, a transmitting apparatus in a Broadband Wireless Access (BWA) system is provided. The apparatus includes a storage for buffering a predetermined number of pieces of past channel information with respect to all terminals; a predictor for predicting a future channel status for each terminal by using the predetermined number of pieces of past channel information; and a scheduler for scheduling by assigning a high priority to a terminal of which the future channel status has possibility of becoming worse, by using channel prediction values obtained from the predictor.

According to another aspect of the present invention, a transmitting method in a BWA system is provided. The method includes buffering a predetermined number of pieces of past channel information with respect to all terminal; predicting a future channel status for each terminal by using the predetermined number of pieces of past channel information; and scheduling by assigning a high priority to a terminal of which the future channel status has possibility of becoming worse, by using channel prediction values obtained from the predictor.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a case where one cell area is divided into five areas according to a channel level;

FIGS. 2A to 2D illustrate changes in a channel status with respect to a movement of a terminal;

FIGS. 3A and 3B are diagrams for illustrating a scheduling algorithm according to the present invention;

FIG. 4 is a block diagram illustrating a structure of a Base Station (BS) in a Broadband Wireless Access (BWA) system according to the present invention;

FIG. 5 is a block diagram illustrating a detailed structure of a scheduler according to the present invention;

FIG. 6 is a flowchart illustrating an operation of a BS in a BWA system according to the present invention;

FIG. 7 illustrates a process of making a scheduling priority list according to the present invention;

FIG. 8 illustrates an example of a real implementation of the present invention;

FIG. 9 is a graph for comparing total throughputs;

FIG. 10 is a graph for comparing delays; and

FIG. 11 is a graph for comparing jitters.

### DETAILED DESCRIPTION OF THE INVENTION

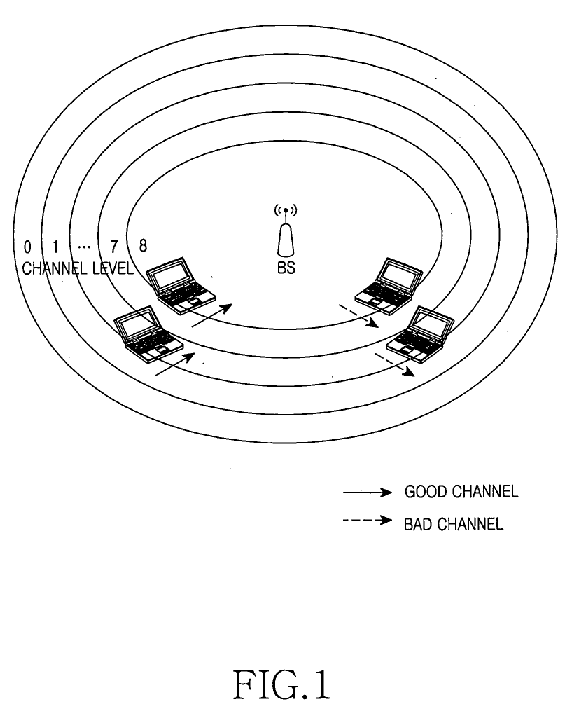

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Hereinafter, a method of the present invention will be described in which a future channel status is predicted for respective users, and a scheduling priority is assigned to each user by using the predicted channel status in a Broadband Wireless Access (BWA) system.

The BWA system is a communication system using Orthogonal Frequency Division Multiplexing (OFDM) or Orthogonal Frequency Division Multiple Access (OFDMA). Although the BWA system will hereinafter be described for example, the present invention may also apply to any other mobile communication systems as long as a terminal has mobility.

An OFDMA-Time Division Duplexing (OFDMA-TDD) system is a promising candidate for a next generation mobile communication system. In the OFDMA-TDD system, a frame with a specific length (e.g., 5 ms) is divided into an UpLink (UL) region and a DownLink (DL) region. Resource allocation information (e.g., MAP) for indicating UL/DL resources allocated to terminals is provided to a front portion of each frame. A data transmission period is constructed of slots including a sub-channel and an OFDMA symbol. A data size that can be transmitted in each slot varies depending on a channel status. That is, data modulation is carried out in different manners according to the channel status. The better the channel status, the higher a data transmission rate.

In an OFDMA-based cellular system, the channel status is divided into several states, and a suitable modulation level (e.g., MCS level) is defined for each state.

FIG. 1 shows a case where one cell area is divided into N areas according to a channel level (or a modulation level). In FIG. 1, a terminal located near a Base Station (BS) has a good channel status, and thus a service can be provided with a high transmission rate, whereas a terminal located far from the BS receives a service with a low transmission rate taking into consideration errors. That is, the closer to a center of the cell, the higher the transmission rate. In addition, the closer to an edge of the cell, the lower the transmission rate.

Now, mobility modeling and channel modeling of a terminal according to the present invention will be described.

First, the mobility modeling will be described. Examples of the mobility modeling for making a movement pattern of the terminal include a fluid model, a random movement model, a Markov model, etc. In the present invention, a Gauss-Markov model, which has a linear directivity and a smooth movement pattern, is assumed to be used. When directivity and speed are considered in the linear movement, the Gauss-Markov model is more appropriate in a metropolitan environment than other mobility models.

Next, the channel modeling will be described. The wireless channel modeling can show a channel status between a BS and a terminal in a realistic way. The wireless channel modeling may be used when one cell range is divided into several level zones each having a different data transmission rate and a modulation method. The modulation method Hₖ(t) for each zone can be expressed by Equation 1 below:

Hₖ(t)=\sqrt{Hₖ^{P}(t)·Hₖ^{S}}(t). [Eqn. 1]

In Equation 1, Hₖ^{P}(t) denotes a path loss, and Hₖ^{S} denotes shadow fading. The path loss Hₖ^{P}(t) and the shadow fading Hₖ^{S} can be expressed as Equation 2 below:

Hₖ^{P}(t)=C·(max(rₖ(t),r₀))^{-α}C=10^{-2.86}(path loss)

Hₖ^{S}(t)=10^{X}^{ₖ}^{(t)/10}. [Eqn. 2]

In Equation 2, rₖ(t) denotes a distance between the terminal and the BS, and r₀ denotes a minimal distance between the terminal and the BS. Xₖ(t) and ρ(d) can be expressed as Equation 3 below:

Xₖ(t)=ρ(d)·Xₖ(t−1)+\sqrt{1−ρ²(d)}·X′

ρ(dₖ)=exp(−dₖ1n2/d_{cor}). [Eqn. 3]

In Equation 3, Xₖ(t) denotes a ‘zero-mean Gaussian random process’, dₖ denotes a movement distance of the terminal, and d_{cor} denotes a correlation distance of the shadow fading.

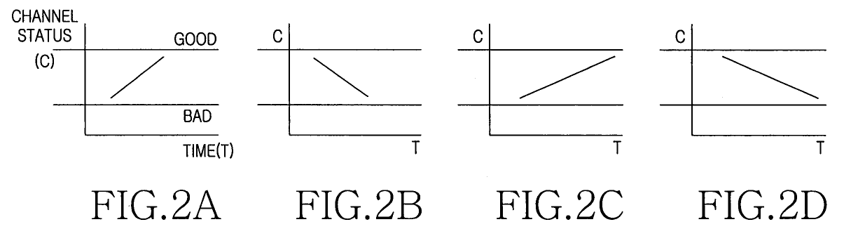

In the mobile communication system, the channel status resulted from the movement of the terminal is determined by a distance between the BS and the terminal and the fading. However, a channel change of the terminal is closely related to a speed. For example, the channel change resulted from the movement of the terminal within one cell range is shown in FIGS. 2A to 2D. If the terminal of FIG. 1 moves from a first zone to a fifth zone, the channel status increases as shown in FIG. 2A and FIG. 2C. If the terminal of FIG. 1 moves from the fifth zone to the first zone, the channel status decreases as shown in FIG. 2B and FIGURE D. FIG. 2A and FIG. 2C are differentiated by a movement speed. That is, when the terminal moves fast, a slope representing changes in the channel status shows an abrupt change, and when the terminal moves slowly, the slop representing changes in the channel status shows a slow change.

Therefore, the BS can predict a future channel status by applying channel information to a time-series prediction method, wherein the channel information is periodically fed back from the terminal. That is, an average channel variation is computed by using a plurality of pieces of channel information which are recently fed back, and the future channel status is predicted by using a latest channel status and the computed channel variation. This can be expressed as Equation 4 below:

$$channel status variation ( Δ {\overline{V}}_{i} ( t ) ) \\ Δ {\overline{V}}_{i} ( t ) = \frac{1}{k} {\sum }_{x = 0}^{k - 1} ( {V}_{i} ( {t}_{k - x} ) - {V}_{i} ( {t}_{k - ( x + 1 )} ) ) \\ channel status prediction value ( {\tilde{V}}_{i} ( {t}_{n + 1} ) ) \\ {\tilde{V}}_{i} ( {t}_{n + 1} ) = {V}_{i} ( {t}_{n} ) + Δ {\overline{V}}_{i} ( {t}_{n} ) . \qquad [ Eqn . 4 ]$$

In Equation 4, Vᵢ(tₙ) denotes a channel status for an i^{th} terminal at an n^{th} time.

The present invention is provided to control a scheduling priority of a terminal when DL scheduling is performed in a condition where a modulation method of the terminal may change according to the predicted channel state.

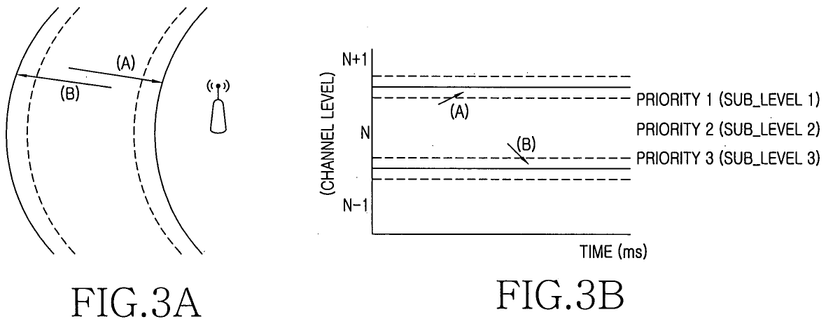

FIGS. 3A and 3B are diagrams for illustrating a scheduling algorithm according to the present invention.

Referring to FIGS. 3A and 3B, a solid line indicates a channel status borderline at which a modulation level (or a channel level) changes. A dotted line indicates a range in which the modulation level has possibility of changing. An area in which the modulation level has no possibility of changing is defined as a sub-level 2. An area in which the modulation level has possibility of changing to a higher modulation level is defined as a sub-level 1. An area in which the modulation level has possibility of changing to a lower modulation level is defined as a sub-level 3. For example, as shown in FIG. 3A, if a predicted channel status changes to the sub-level 1 in a state where the terminal receives a service with a modulation level of N, the channel status has possibility of changing to a higher modulation level in a later time. Therefore, in this case, a resource allocation priority for the terminal decreases. On the other hand, as shown in FIG. 3B, if the predicted channel status changes to the sub-level 3, the channel status has possibility of changing to the low modulation level at a later time. Therefore, a resource allocation priority for the terminal increases. That is, a scheduling priority increases so that data is transmitted as much as possible before the channel status further deteriorates.

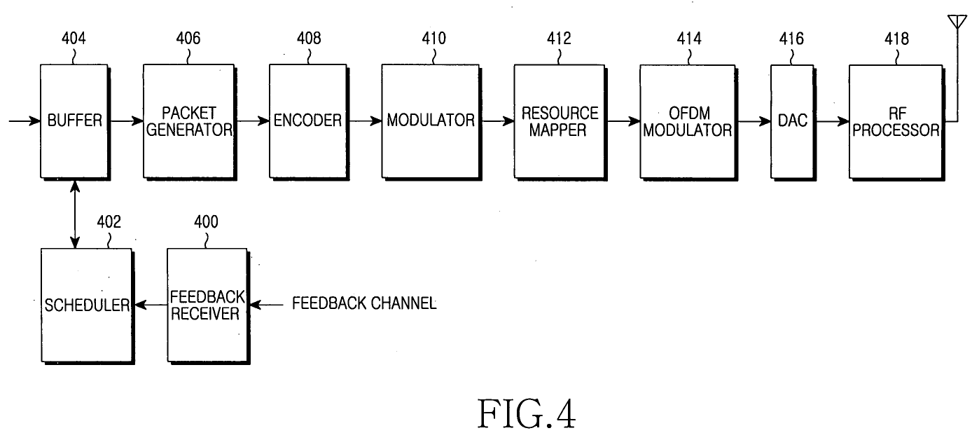

FIG. 4 is a block diagram illustrating a structure of a BS in a BWA system according to the present invention.

Referring to FIG. 4, the BS includes a feedback receiver 400, a scheduler 402, a buffer 404, a packet generator 406, an encoder 408, a modulator 410, a resource mapper 412, an OFDM modulator 414, a Digital to Analog Converter (DAC) 416, and a Radio Frequency (RF) processor 418.

The feedback receiver 400 receives a plurality of pieces of channel information periodically fed back from terminals, and provides the pieces of channel information to the scheduler 402.

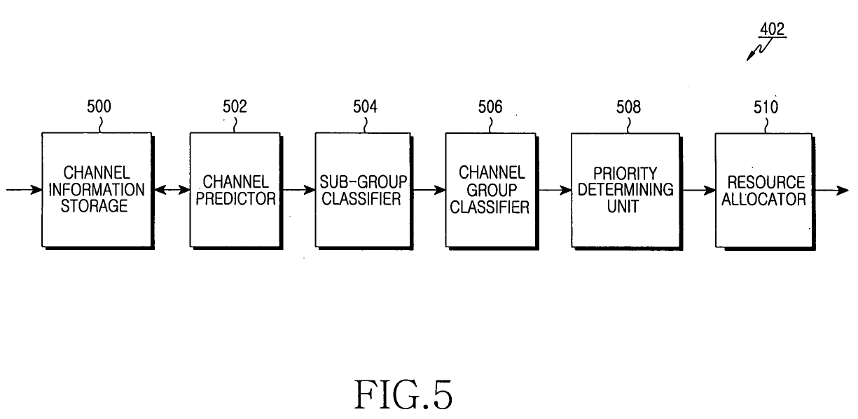

The scheduler 402 buffers, for each terminal, the channel information in a specific window size, computes an average channel variation by using a predetermined number of pieces of buffered channel information, and predicts a next channel status by using latest channel information and the average channel variation. Further, the scheduler 402 determines a scheduling priority of each terminal by using a channel status prediction value for each terminal, performs resource allocation according to the determined priority, and controls data transmission according to the result of the resource allocation. Detailed operations of the scheduler 402 will be described below in detail with reference to FIG. 5.

The buffer 404 buffers data to be transmitted to each terminal, and outputs data to be transmitted to a specific terminal under the control of the scheduler 402. That is, the buffer 404 selects and outputs data of terminals to which resources are allocated during a current frame. The packet generator 406 assembles data received from the buffer 404 into a Packet Data Unit (PDU) of a Media Access Protocol (MAC) layer, and outputs the assembled data.

The encoder 408 encodes packets received from the packet generator 406 in a burst unit, and outputs the encoded data. An encoding rate of a burst is determined according to a scheduling result of the scheduler 402. For example, the encoder 408 may be a convolutional encoder, a turbo encoder, a Convolutional Turbo Code (CTC) encoder, or a Low Density Parity Check (LDPC) encoder.

The modulator 410 modulates symbols encoded by the encoder 408 in a predetermined modulation method, and thus generates modulated symbols. Examples of the modulation method used by the modulator 410 include Quadrature Phase Shift Keying (QPSK), a 16Quardrature Amplitude Modulation (QAM), and a 32QAM.

The resource mapper 412 maps complex symbols, which are provided from the modulator 410, to sub-carriers according to the scheduling result of the scheduler 402. Specifically, the resource mapper 412 maps the complex symbols to the sub-carrier, sorts the complex symbols in a frame unit, and sequentially outputs the sorted complex symbols on the basis of time synchronization.

The OFDM modulator 414 performs an Inverse Fast Fourier Transform (IFFT) operation on the complex symbols received from the resource mapper 412, and thus converts the complex symbols into sample data in a time domain. Then, the OFDM modulator 414 outputs sample data by appending a Cyclic Prefix (CP).

The DCA 416 converts the sample data received from the OFDM modulator 414 into sample data. The RF processor 418 includes a frequency synthesizer, a filter, etc. Further, the RF processor 418 converts a baseband signal received from the DCA 416 into an RF signal so that the signal can be transmitted. Thereafter, the converted RF signal is transmitted through an antenna.

FIG. 5 is a block diagram illustrating a detailed structure of the scheduler 402 according to the present invention.

Referring to FIG. 5, the scheduler 402 includes a channel information storage 500, a channel predictor 502, a sub-group classifier 504, a channel group classifier 506, a priority determining unit 508, and a resource allocator 510.

The channel information storage 500 buffers a plurality of pieces of channel information fed back from terminals in a predetermined window size. The buffered channel information is latest information. When new channel information is received, oldest channel information is discarded, and the new channel information is stored as the latest information.

The channel predictor 502 accesses the channel information storage 500 periodically or when a specific event occurs, and then reads the buffered channel information. Then, the channel predictor 502 computes a channel variation for each terminal by using the read channel information. Further, the channel predictor 502 predicts a next channel status by using latest channel information of each terminal and the computed channel variation. That is, the channel predictor 502 predicts the next channel status by performing time-series prediction as expressed by Equation (4) above.

The sub-group classifier 504 classifies the terminals into three sub-groups by using channel prediction values provided from the channel predictor 502. As shown in FIGS. 3A and 3B, a terminal is classified into the sub-group 2 when the channel prediction value corresponds to the sub-level 2. The terminal is classified into the sub-group 1 when the channel prediction value corresponds to the sub-level 1. The terminal is classified into the sub-group 3 when the channel predication value corresponds to the sub-level 3. When the terminal belongs to the sub-group 1, the terminal has a high possibility of changing to a higher modulation level. When the terminal belongs to the sub-group 3, the terminal has a high possibility of changing to a low modulation level. In this case, the sub-group 3 has a highest scheduling priority, followed by the sub-group 2. The sub-group 1 has a lowest scheduling priority.

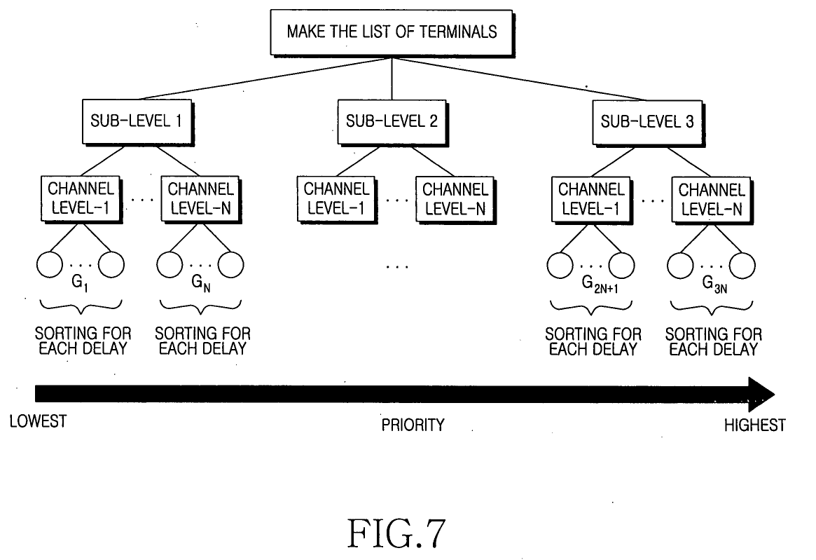

With respect to all sub-groups generated by the sub-group classifier 504, the channel group classifier 506 classifies the terminals according to a channel level. For example, if the system provides N channel levels (or modulation levels), as shown in FIG. 7, for each sub-group, the terminals are classified into N channel groups according to the channel level. In this case, the higher the channel level, that is, the better the channel status, the higher the scheduling priority.

As shown in FIG. 7, the priority determining unit 508 sorts the total number of 3×N channel groups generated by the channel group classifier 506 according to scheduling priority. For each channel group, the priority determining unit 508 sorts the terminals according to a scheduling delay value, and then determines a priority of each terminal. The delay value represents a delay time in which data of a terminal waits in a transmission queue. That is, a high priority is assigned to the terminal of which data waits long in the transmission queue. In this manner, a resource allocation priority list is made. Consequently, as shown in FIG. 7, regarding the resource allocation priority, a sub-group of a terminal of which a future channel status has a possibility of becoming worse has a higher priority than a sub-group of a terminal of which a future channel status has a possibility of becoming better. Regarding the same sub-group, a group (i.e., a channel group) of terminals each having a good channel level has a higher priority than a group of terminals each having a worse channel level. Regarding the same channel group, the higher the transmission delay value of a signal (transmission data), the higher the priority.

The resource allocator 510 performs resource scheduling according to the priority list created by the priority determining unit 508. That is, the scheduling is performed in such a way that the resource allocator 510 first allocates a resource to a terminal of which a future channel status has a possibility of becoming worse in a later time, so that data can be transmitted as much as possible before the channel level changes.

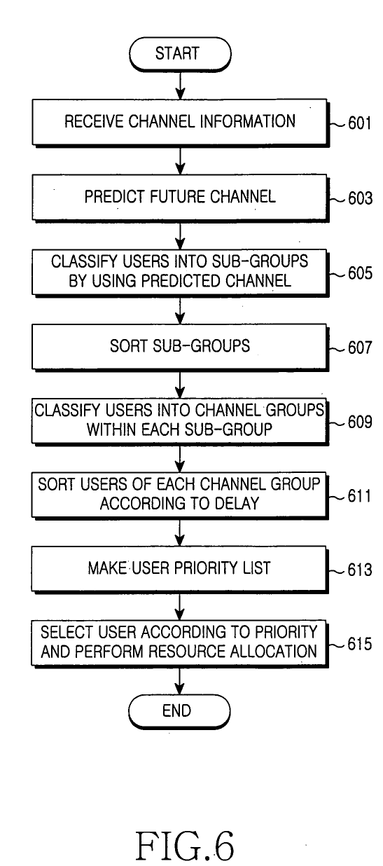

FIG. 6 is a flowchart illustrating an operation of a BS in a BWA system according to the present invention.

Referring to FIG. 6, the BS buffers a plurality of pieces of channel information fed back from terminals in a predetermined window size in step 601. The buffered channel information is latest information. When new channel information is received, oldest channel information is discarded, and the new channel information is stored as the latest information.

In step 603, the BS accesses to the pieces of buffered channel information periodically or when a specific event occurs, and then computes an average channel variation for each terminal by using the pieces of buffered channel information. The BS predicts a next channel status (a future channel status) by using latest channel information for each terminal and the computed average channel variation. The BS may predict the future channel status by performing the time-series prediction as expressed by Equation (4) above.

Upon predicting the future channel status for each terminal, in step 605, the BS classifies the terminals into three sub-groups by using the predicted channel values. As shown in FIGS. 3A and 3B, a terminal is classified into the sub-group 2 when the channel prediction value corresponds to the sub-level 2. The terminal is classified into the sub-group 1 when the channel prediction value corresponds to the sub-level 1. The terminal is classified into the sub-group 3 when the channel predication value corresponds to the sub-level 3. In this case, the sub-group 3 has a highest priority, followed by the sub-group 2. The sub-group 1 has a lowest priority. In step 607, the BS sorts the three sub-groups according to the priorities.

In step 609, for each sub-group, the BS classifies the terminals according to a channel level. For example, if the system provides N channel levels (or modulation levels), as shown in FIG. 7, for each sub-group, the terminals are classified into N channel groups according to the channel level. In this case, the higher the channel lever, the higher the priority.

In step 611, the BS sorts the previously generated 3×N channel groups according to priority, and also sorts the terminals for each channel group according to a transmission delay value of a signal (Transmission (Tx) data), and thus determines a priority for each terminal. In step 613, the BS creates a resource allocation priority list (i.e., a user priority list) according to the determined priority.

In step 615, the BS performs scheduling according to the priority list, and then allocates a resource to each terminal. In this case, scheduling is carried out in such a way that a terminal of which a future channel status has a possibility of becoming worse is preferentially allocated with a resource, and thus data can be transmitted as much as possible before a channel level changes.

FIG. 7 illustrates a process of making a scheduling priority list according to the present invention.

As shown in FIG. 7, a list of terminals requiring resource allocation is made. Thereafter, the terminals are classified into three sub-groups (or sub-levels) according to a channel state prediction value. Then, for each sub-group, the terminals are classified according to a channel level. For example, if the number of channel levels (or modulation levels) provided by a system is N, the terminals are classified into N channel groups for each sub-group. In this case, the higher the channel level, the higher the priority. Finally, for each channel group, the terminals are sorted according to a delay value of Tx data, and thus a priority of each terminal is determined. In FIG. 7, a sub-group of terminals of which a future channel status has a possibility of becoming worse has a higher priority than a sub-group of terminals of which a future channel status has possibility of becoming better. Regarding the same sub-group, a group (i.e., a channel group) of terminals having a good channel level has a higher priority than a group of terminals having a worse channel level. Regarding the same channel group, the greater the transmission delay value of the Tx data, the higher the priority.

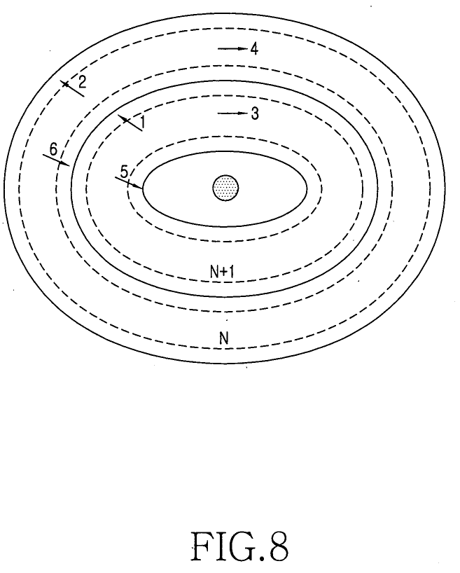

FIG. 8 illustrates an example of a real implementation of the present invention.

In FIG. 8, N and N+1 each indicate a channel level (or a modulation level). An arrow indicates a channel change of a terminal. Numeric characters each indicate a resource allocation priority, wherein 1 is a highest priority, and 5 is a lowest priority. As shown in FIG. 8, terminals (with priorities of 1 and 2) each of which a channel level has possibility of becoming worse are assigned with high priorities, followed by terminals (with priorities of 3 and 4) each of which a channel level has no possibility of changing. Terminals (with priorities of 5 and 6) each of which a channel level has possibility of becoming better are assigned with lower priorities. Meanwhile, regarding the same sub-group, a high priority is assigned to a terminal having a good channel level.

Now, a simulation result will be described which has been performed to evaluate performance of the present invention.

First, a simulation environment is assumed to be as follows.

One sub-channel is used in an OFDMA-TDD system. One frame has a length of 5 ms. The number of sub-carriers is 8. The number of DL symbols is 12. The number of all slots within a frame is 96.

A channel level depending on a Signal to Noise Ratio (SNR) is defined as shown in Table 1 below.

TABLE 1

| | | Service |
|---|---|---|
| SNR (r) | Channel Level | Transmission Rate (bytes/slot) |
| R < −65.94 | 1 | 16 |
| −65.94 ≦ r < −64.85 | 2 | 24 |
| −64.85 ≦ r < −63.31 | 3 | 32 |
| −63.31 ≦ r < −60.68 | 4 | 40 |
| −60.68 ≦ r | 5 | 48 |

A cell radius is 1 km. A future channel status is predicted by using three pieces of old channel information. A traffic model is assumed to be a Web traffic model (i.e., On-Off module) which is defined by an Institute of Electrical and Electronics Engineers (IEEE) 802.20 Mobile BWA (MBWA) system simulation (i.e., IEEE 802.20-03/66).

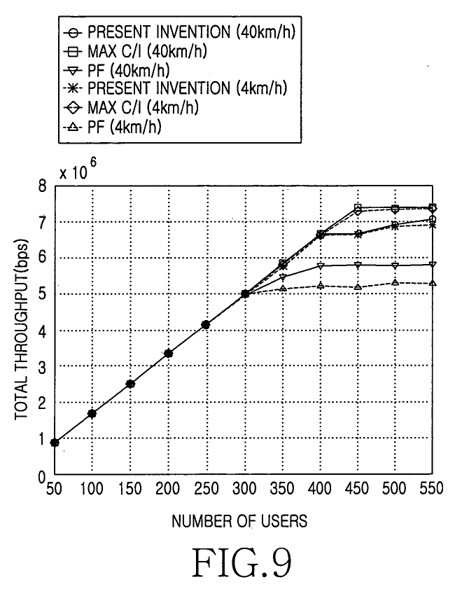

FIG. 9 is a graph for comparing total throughputs.

Referring to FIG. 9, total throughputs (unit: bps) are shown with respect to the number of users. In a saturation state, the present invention shows a slightly lower performance than the Max C/I algorithm but a higher performance than the PF algorithm. The reason above is that, in the Max C/I algorithm, a throughput continuously increases because a user having a good channel state is prioritized without considering a delay time or a jitter, and in the PF algorithm, a throughput starts to decrease ever since the number of users reaches 300, and then the throughput enters a saturation state because a fair transmission rate is taken into account.

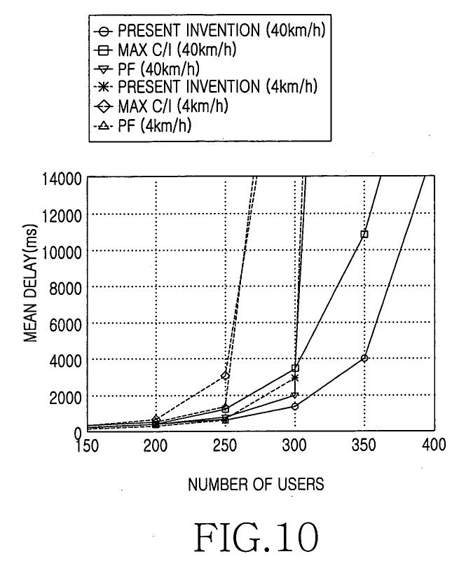

FIG. 10 is a graph for comparing delays.

The graph of FIG. 10 shows that the present invention has a better performance than two other algorithms (i.e., Max C/I and PF). In FIG. 10, delays are compared when the number of users is in the range of 150 and 400. If the number of users is greater than that, an overflow occurs in a buffer of the BS, and thus a delay time abruptly increases. Therefore, comparison has not been made when the number of users is greater than 400. Since the PF algorithm provides a fair service to each user over the entire throughput, the graph shows that the delay time abruptly increases when the number of users is 300 at 40 km/h, and 250 at 4 km/h. That is, the present invention shows a better performance than the Max C/I algorithm.

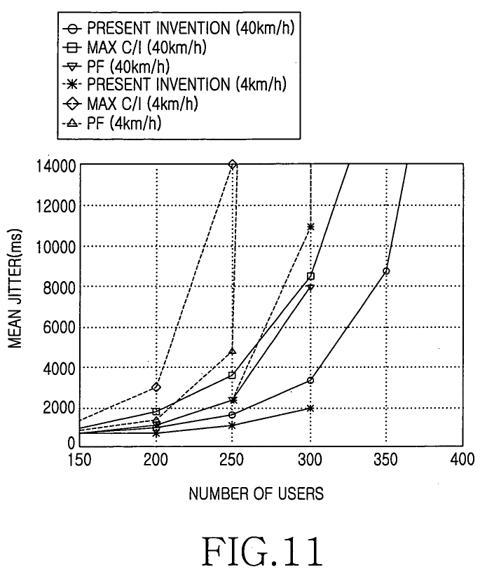

FIG. 11 is a graph for comparing jitters.

The graph of FIG. 11 shows that the present invention has a better performance than two other algorithms (i.e., Max C/I and PF). The PF algorithm shows a better performance than the Max C/I algorithm. However, a jitter value abruptly increases when the number of users is 300 at 40 km/h, and 250 at 4 km/h. The reason above is that, the PF algorithm provides a fair service to each user over the entire throughput.

As described above, the present invention shows a better performance than the conventional algorithms (i.e., Max C/I and PF) in terms of total throughput, delay, and jitter.

According to the present invention, a scheduling priority is determined by predicting a future channel status of a mobile terminal which is currently receiving a service, that is, scheduling is performed by predicting a channel at a time when data is transmitted. Therefore, a further effective scheduling can be achieved. In addition, as described with reference to FIG. 9 and FIG. 10, the present invention has a better performance than the conventional algorithms in terms of total throughput, delay, and jitter.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A transmitting apparatus in a Broadband Wireless Access (BWA) system, the apparatus comprising:
a storage for buffering a predetermined number of pieces of past channel information with respect to terminals;
a predictor for predicting a future channel status for each terminal by using the predetermined number of pieces of past channel information; and
a scheduler for scheduling by assigning a high priority to a terminal of which the future channel status has a possibility of becoming worse, using channel prediction values obtained from the predictor.

2. The apparatus of claim 1, wherein the scheduler comprises a sub-group classifier for classifying the terminals into sub-groups by using the channel prediction values obtained by the predictor, and for determining a scheduling priority for each sub-group.

3. The apparatus of claim 2, wherein the sub-group classifier classifies a terminal of which a channel level has possibility of becoming better into a first sub-group, the terminal of which a channel level has no possibility of changing into a second sub-group, and the terminal of which channel level has possibility of becoming worse into a third sub-group.

4. The apparatus of claim 3, wherein the sub-group classifier assigns a highest priority to the third sub-group, and assigns a lowest priority to the first sub-group.

5. The apparatus of claim 2, wherein the scheduler further comprises a channel group classifier for classifying the terminals into channel groups according to a channel level for each of the three sub-groups generated by the sub-group classifier, and for determining a scheduling priority for the channel group.

6. The apparatus of claim 5, wherein the channel group classifier assigns a priority in such a way that the better a channel status of the channel group, the higher the scheduling priority of the channel group.

7. The apparatus of claim 5, wherein the scheduler further comprises a priority determining unit for sorting the terminals according to a delay value for each channel group generated by the channel group classifier, and for determining a priority for each terminal.

8. The apparatus of claim 7, wherein the priority determining unit assigns a priority in such a way that the greater the delay value of the terminal, the higher the priority of the terminal.

9. The apparatus of claim 7, wherein the scheduler further comprises a resource allocator for scheduling according to the priority determined by the priority determining unit.

10. The apparatus of claim 1, wherein the predictor computes an average channel variation by using the predetermined number of pieces of past channel information for each terminal, and predicts a next channel status by using latest channel information of the terminal and the average channel variation.

11. The apparatus of claim 1, further comprising a transmitter for transmitting data of the scheduled terminals according to a scheduling result of the scheduler.

12. The apparatus of claim 11, wherein the transmitter comprises:
a buffer for buffering transmission (TX) data, and for outputting data of the terminals to which resources are allocated during a current frame under a control of the scheduler;
a packet generator for assembling the data from the buffer into packets of a Media Access Control (MAC) layer;
a physical layer encoder for performing physical-layer encoding on the packets generated by the packet generator; and
a Radio Frequency (RF) processor for converting a signal provided from the physical layer encoder into an RF signal, and for transmitting the RF signal.

13. A transmitting method in a Broadband Wireless Access (BWA) system, the method comprising:
buffering a predetermined number of pieces of past channel information with respect to terminals;
predicting a future channel status for each terminal using the predetermined number of pieces of past channel information; and
scheduling by assigning a high priority to a terminal of which the future channel status has a possibility of becoming worse, by using channel prediction values obtained from the predictor.

14. The method of claim 13, wherein scheduling comprises:
classifying the terminals into sub-groups using the channel prediction values; and
determining a scheduling priority for each sub-group.

15. The method of claim 14, wherein, in the step of classifying the terminals into sub-groups, a terminal of which channel level has a possibility of becoming better is classified into a first sub-group, the terminal of which channel level has no possibility of changing is classified into a second sub-group, and the terminal of which channel level has possibility of becoming worse is classified into a third sub-group.

16. The method of claim 15, wherein, in the step of determining the scheduling priority of each sub-group a highest priority is assigned to the third sub-group, and a lowest priority is assigned to the first sub-group.

17. The method of claim 14, wherein the step of scheduling comprises:
classifying the terminals into channel groups according to a channel level for each sub-group; and
determining a scheduling priority for each channel group.

18. The method of claim 17, wherein, in the step of determining the scheduling priority for each channel group the priority is assigned in such a way that the better the channel status of the channel group, the higher the priority of the channel group.

19. The method of claim 17, wherein the step of scheduling further comprises sorting the terminals according to a delay value for each channel group, and determining a priority for each terminal.

20. The method of claim 19, wherein the priority is assigned in such a way that the greater the delay value of the terminal, the higher the priority of the terminal.

21. The method of claim 19, wherein the step of scheduling further comprises scheduling according to the priority, and allocating a resource to each terminal.

22. The method of claim 13, wherein the step of predicting the future channel status comprises:
computing an average channel variation using the predetermined number of pieces of past channel information for each terminal; and
predicting a next channel status using latest channel information of the terminal and the average channel variation.

23. The method of claim 13, further comprising selecting and transmitting data of the terminals according to a scheduling result.

24. The method of claim 23, wherein the step of transmitting the data comprises:
selecting the data of the terminals to which resources are allocated during a current frame according to the scheduling result;
assembling the selected data into packets of a Media Access Control (MAC) layer;
performing physical-layer encoding on the packets of the MAC layer; and
converting the encoded signal into a Radio Frequency (RF) signal and transmitting the RF signal.
